(19) United States
(12) Patent Application Publication
(10) Pub. No.: US 2009/0193482 A1
(43) Pub. Date: Jul. 30, 2009

(54) System and Method of Scheduling Recording of Media Content

(75) Inventors: Scott White, Austin, TX (US); James Cansler, JR., Pflugerville, TX (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T Knowledge Ventures, L.P., Reno, NV (US)

(21) Appl. No.: 12/019,820

(22) Filed: Jan. 25, 2008

(51) Int. Cl. H04N 7/173

(52) U.S. Cl. 725/110

(57) ABSTRACT

A method at a set-top box. The method includes receiving a signal including media content. The method also includes determining a signal quality metric of the first signal. The method also includes scheduling recording of the media content via a second signal after determining that the signal quality metric of the first signal is below a specified threshold.

### FIELD OF THE DISCLOSURE

The present disclosure is generally related to scheduling recording of media content.

### BACKGROUND

Modern communication networks may be used to deliver media content, such as movies, television shows, or video-on-demand programs, to subscribers. Such communication networks may include a satellite transmission, a cable network, a fiber optic network, or an internet protocol based network. One problem with delivering media content to subscribers relates to degradation of the signal quality of the signal received by the subscribers. For example, inclement weather may occasionally degrade the signal quality of a satellite transmission. If a subscriber is viewing or recording media content and the quality of the signal degrades, the subscriber may not be able to view or record all of the media content.

### BRIEF DESCRIPTION OF THE DRAWINGS

FIG. 1 is a block diagram of an embodiment of a system for scheduling recording of media content;

FIG. 2 is a flow diagram of a first particular embodiment of a first method of scheduling recording of media content;

FIG. 3 is a flow diagram of a second particular embodiment of a second method of scheduling recording of media content;

FIG. 4 is a flow diagram of a third particular embodiment of a third method of scheduling recording of media content;

FIG. 5 is a flow diagram of a fourth particular embodiment of a fourth method of scheduling recording of media content; and

FIG. 6 is a block diagram of an illustrative embodiment of a general computer system.

### DETAILED DESCRIPTION

In a particular embodiment, a method at a set-top box is disclosed. The method includes receiving a first signal, the first signal including media content. The method also includes determining a signal quality metric of the first signal. The method also includes scheduling recording of the media content via a second signal after determining that the signal quality metric of the first signal is below a specified threshold.

In another embodiment, a method at a digital video recorder is disclosed. The method includes receiving a first signal, the first signal including media content. The method also includes receiving a request to record the media content. The method also includes scheduling a recording of the media content via a second signal after determining that a signal quality metric of the first signal is below a specified threshold.

In another embodiment, a computer-readable storage is disclosed. The computer-readable storage medium includes operational instructions, that when executed by a processor, cause the processor to receive a first signal, the first signal including media content. The computer-readable storage medium further includes operational instructions, that when executed by the processor, cause the processor to determine a signal quality metric of the first signal. The computer-readable storage medium further includes operational instructions, that when executed by the processor, cause the processor to determine whether the media content is available via an alternate transmission after determining that the signal quality metric of the first signal is below a specified threshold.

In another embodiment, a system is disclosed. The system includes an interface to receive a first signal including media content. The system also includes a signal quality module to determine a first signal quality metric of the first signal. The system also includes a media content control module to determine whether the media content is available via a second signal when the first signal quality metric is below a specified threshold. The media content control module also schedules recording of the second signal after determining that the media content is available via a second signal.

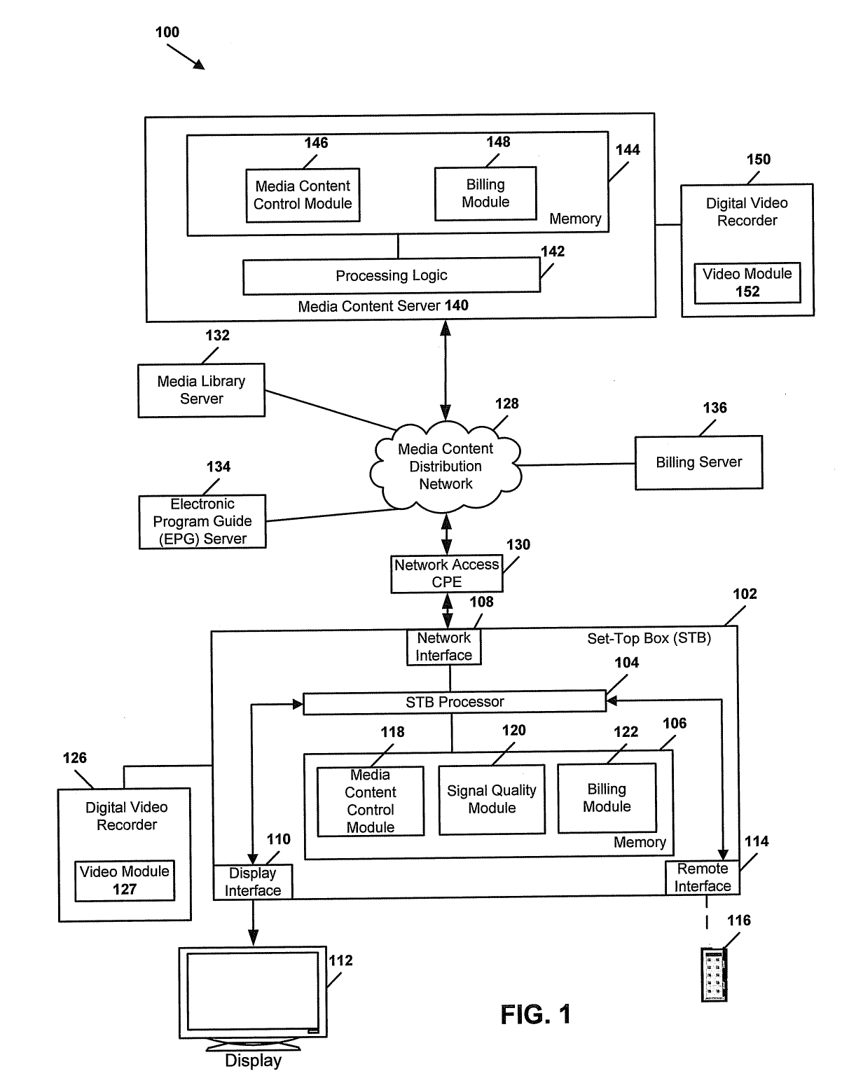

FIG. 1 is a block diagram illustrating an embodiment of a system 100 to schedule recording of media content. In a particular embodiment, the system 100 includes a set-top box (STB) device 102 coupled to a media content distribution network 128 via network access customer premises equipment (CPE) 130. For example, the media content distribution network 128 may include a direct transmission satellite (DBS) transmission network, an Internet Protocol (IP) based network, a hybrid fiber coax (HFC) network, or any combination thereof. The media content distribution network 128 may distribute media content via a signal sent to one or more subscriber devices. A media library server 132, an electronic program guide (EPG) server 134, a billing server 136, and a media content server 140 are also coupled to the media content distribution network 128.

In a particular embodiment, a digital video recorder 150 is coupled to the media content server 140. The digital video recorder 150 may also be known as a network digital video recorder. The digital video recorder 150 may be used to record media content and playback recorded media content. The digital video recorder 150 may include a video module 152 that directs the digital video recorder 150 to perform actions such as determining the quality of a signal received at the digital video recorder 150. The video module 152 may be implemented as software, firmware, hardware, or any combination thereof.

In a particular embodiment, the STB device 102 is configured to display media content received from the media content server 140 via the media content distribution network 128. The STB device 102 includes an STB processor 104 and a memory 106 accessible to the STB processor 104. The STB device 102 communicates with the media content distribution network 128 via a network interface 108. The STB processor 104 is coupled to a display interface 110 to communicate media content to a display device 112. In addition, the STB processor 104 communicates with a remote control 116 via a remote interface 114. A channel for receiving media content may be selected from an input device associated with the STB device 102, such as the remote control 116. For example, the media content may be a television show, a movie, a video-on-demand program, other media content, or any combination thereof.

The STB device 102 may include one or modules adapted to perform various functions. The modules may be implemented as hardware, firmware, software, or any combination thereof. In a particular embodiment, the memory 106 includes a media content control module 118, a signal quality module 120, and a billing module 122. In a particular embodiment, the billing module 122 may include operational instructions executable by the STB processor 104 to record billing information relating to viewing a specific media content, such as a television show or movie, as illustrative, non-limiting examples. In a particular embodiment, the media control module 118 may include operational instructions executable by the STB processor 104 to receive a first signal from the media content server 140 via a first signal received at the network interface 108. For example, the first signal may include media content, such as a television program, a movie, or a video-on-demand program. In a particular embodiment, the media content control module 118 may also include operational instructions executable by the STB processor 104 to provide media content to the display device 112 via the display interface 110.

The STB device 102 may also be configured to communicate with a data storage device, such as a digital video recorder 126. For example, the digital video recorder 126 may be coupled to the set-top box device 102. In another example, the digital video recorder 126 may be integrated with the STB device 102. In a particular embodiment, the STB device 102 may be configured to instruct the digital video recorder 126 to record a signal that includes media content. The digital video recorder 126 may be used to record media content and playback recorded media content. The digital video recorder 126 may include a video module 127 that directs the digital video recorder 127 to perform actions such as determining a signal quality metric of a signal received at the digital video recorder 126. The video module 127 may be implemented as software, firmware, hardware, or any combination thereof.

In a particular embodiment, the set-top box device 102 may be configured to request and receive media content via the media content server 140. The network access CPE 130 may facilitate communication between the network interface 108 and the media content distribution network 128. The network access CPE 130 may include a satellite receiver; a router; a local area network device; a modem, such as a digital subscriber line (DSL) modem; a residential gateway; any other suitable device for facilitating communication between the network interface 108 of the set-top box device 102 and the media content distribution network 128; or any combination thereof.

In a particular embodiment, the signal quality module 120 may include instructions executable by the STB processor 104 to determine a signal quality metric of the first signal. For example, the signal quality module 120 may monitor the first signal in real-time by periodically measuring a signal quality metric of the first signal. Monitoring the signal quality metric of the first signal may include measuring the strength of the first signal, determining a bit-rate of the first signal, determining the signal-to-noise ratio of the first signal, determining another signal quality metric based on the first metric, or any combination thereof. In one illustrative embodiment, the signal quality module 120 may include instructions executable by the STB processor 104 to determine whether the signal quality metric of the first signal is below a specified threshold. The threshold may be specified by a manufacturer of the set-top box, by a media content provider, by a subscriber associated with the STB 102, or any combination thereof.

The signal quality module 120 may also include instructions executable by the STB processor 104 to perform one or more actions after the signal quality module 120 determines that the signal quality metric of the first signal is below a specified threshold. In one illustrative embodiment, after the signal quality module 120 determines that the signal quality metric of the first signal is below the specified threshold, the signal quality module 120 may include instructions executable by the STB processor 104 to determine whether the media content is scheduled for transmission via a second signal. In one illustrative embodiment, the signal quality module 120 may include instructions executable by the STB processor 104 to schedule recording of the media content of the second signal after determining that the media content is scheduled for transmission via the second signal.

In one illustrative embodiment, after the signal quality module 120 determines that the signal quality metric of the first signal is below the specified threshold, the signal quality module 120 may determine whether the received media content is being simulcast, and instruct the STB 102 to receive the simulcast signal. A simulcast is the simultaneous transmission of media content on more than one channel. Prior to switching the STB device 102 to receive the simulcast signal, the signal quality module 120 may determine a signal quality metric of the simulcast signal and instruct the STB 102 device to receive the simulcast signal after determining that the signal quality metric of the simulcast signal is greater than the specified threshold or greater than the signal quality metric of the first signal. For example, if a subscriber is in the midst of viewing or recording media content when the signal degrades, switching to a simulcast signal with a better signal quality allows the viewer to continue to view or record the media content with minimal interruption. The signal quality module 120 may determine whether specific media content is being simulcast by querying the EPG server 134.

In one illustrative embodiment, the media content control module 118 may be executable by the STB processor 104 to determine whether the media content will be re-transmission when the signal degrades, and to instruct a digital video recorder to record the re-transmission. For example, if a subscriber is in the midst of viewing or recording media content when the signal degrades, the subscriber may later finish viewing or recording the media content via the re-transmission. The signal quality module 120 may determine whether a specific media content is scheduled to be re-transmitted by querying the EPG server 134.

In a particular embodiment, the media content server 140 includes processing logic 142, memory 144, and the digital video recorder 150. The memory 144 includes a media content control module 146 and a billing module 148. The media content control module 146 may include instructions executable by the processing logic 142 to receive one or more media content requests from the STB device 102. The media content control module 146 may also include instructions executable by the processing logic 142 to send media content to the STB device 102. For example, the media content may be a television show, a movie, or a video-on-demand program.

In a particular embodiment, the billing module 148 may include instructions executable by the processing logic 142 to receive billing data from the STB device 102. The digital video recorder 150 may is adapted to record, store, and send one or more media content segments to the STB device 102.

The set-top box device 102 and the media content server 140 may communicate with the media library server 132, the electronic program guide (EPG) server 134, the billing server 136, or any combination thereof, via the media content distribution network 128. The media library server 132 may store the media content, such as television shows, movies, and video-on-demand programs, which can be distributed by the media content server 140. The EPG server 134 may provide information about the media content scheduled for delivery to the STB device 102, such as a start time of the media content, an end time of the media content, the type of the media content, rating information describing the intended audience of the media content, other information about the media content, or any combination thereof. The billing server 136 may periodically receive billing information from the billing module 122, the billing module 148, or both and use the billing information to generate a bill for the subscriber.

For ease of explanation, the various modules 118-122 and 146-148 have been described in terms of processor-executable instructions. However, those skilled in the art will appreciate that such modules can be implemented as hardware logic, processor-executable instructions, or any combination thereof. In addition, although a single STB device 102 is illustrated, the system 100 may include any number of STB devices. Additionally, the various servers 132, 134, 136, and 140 can include one or more computing devices adapted to implement the various server functions. The STB device may include any device capable of receiving media content via a media content distribution network 128, such as a personal digital assistant (PDA), a cell phone, a portable media device, or any other device configured to receive the media content and send the content to a display.

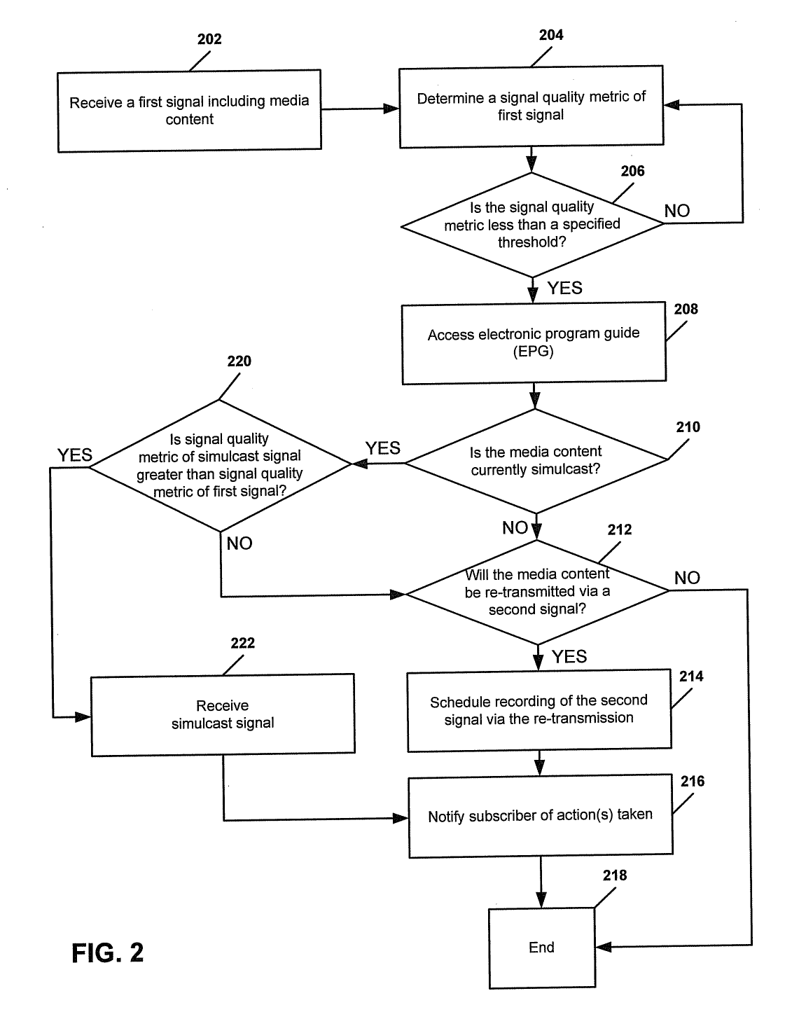

FIG. 2 is a flow diagram of a first particular embodiment of method of scheduling recording of media content. At 202, a first signal including media content is received. For example, the signal may be received at a set-top box device, such as the set-top box device 102, or at a digital video recorder, such as the digital video recorder 126 in FIG. 1. For example, the media content may include a television show, movie, or video-on-demand program. Moving to 204, the signal quality metric of the first signal is determined. For example, the signal quality metric of the first signal may be determined by sampling the first signal and determining the signal quality metric of the sample, or the signal quality metric of the first signal may be monitored in real-time. For example, the signal quality metric of the sample may be determined by measuring the strength of the first signal, measuring the signal-to-noise ratio of the first signal, measuring the bit-rate of the first signal, or any combination thereof. Moving to 206, a determination is made whether the signal quality metric is less than a specified threshold. When the signal quality metric is not less than the specified threshold, the method returns to 204 to determine the signal quality metric of the first signal.

When the signal quality metric is less than the specified threshold, the method proceeds to 208, where an electronic program guide is accessed. For example, an electronic program guide server, such as the EPG server 134 in FIG. 1, may be queried to determine whether the media content is available via an alternate transmission, such as a simulcast or re-transmission. The method advances to 210 where a determination is made whether the media content is currently simulcast. When the media content is not currently simulcast, the method advances to 212, where a determination is made whether the media content will be re-transmitted via a second signal. When the media content will not be re-transmitted, the method ends at 218. When the media content will be re-transmitted, the method continues to 214, where recording of the media content via the re-transmission is scheduled. The method then proceeds to 216, where a subscriber may be notified of the actions taken and the method ends, at 218. For example, the subscriber may be notified that the re-transmission of the content is scheduled for recording at a later date and time because the signal quality metric of the media content fell below a specified threshold.

Returning to 210, when the media content is currently simulcast, at 220 a determination is made whether the signal quality metric of the simulcast is greater than the signal quality metric of the first signal. When the signal quality metric of the simulcast signal is not greater than the signal quality metric of the first signal, the method proceeds to 212 and determines whether the media content will be re-transmitted via a second signal. When the signal quality metric of the simulcast signal is greater than the signal quality metric of the first signal, the method advances to 222 where the simulcast signal is received. For example, if the subscriber is viewing media content on a first channel and the signal quality metric of the signal on the first channel drops below a specified threshold, then the channel is changed to a second channel so that the subscriber can view the media content on the second channel. In another example, if a digital video recorder (DVR) is recording media content on a first channel and the signal quality metric of the signal on the first channel drops below a specified threshold, then the channel is changed to a second channel to allow the DVR to record the media content on the second channel. The method then proceeds to 216 where the subscriber may be notified of the action(s) taken, and the method ends, at 218. For example, the subscriber may be notified that the channel was changed from a first channel to a second channel because the signal quality metric of the first channel was below a specified threshold.

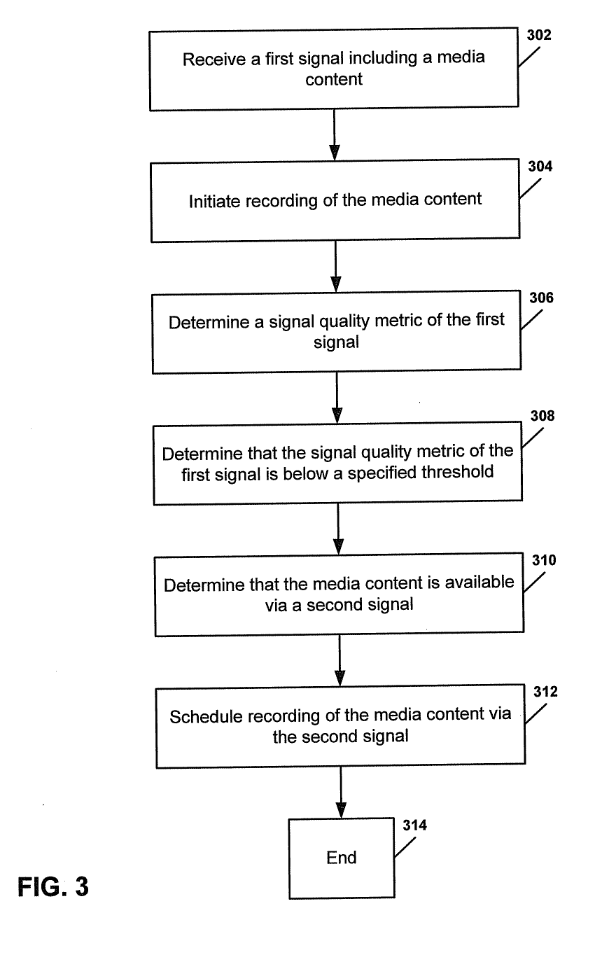

FIG. 3 is a flow diagram of a second particular embodiment of method of scheduling recording of media content. At 302, a first signal is received. For example, the first signal may be received at a set-top box device via a satellite transmission, an Internet Protocol transmission, or a cable transmission. The first signal may include media content, such as a television show, movie, or video-on-demand program. Moving to 304, a recording of the media content is initiated at a digital video recorder, such as the digital video recorder 126 or the digital video recorder 150 as illustrated in FIG. 1. For example, the set-top box may instruct the digital video recorder to initiate recording of media content or the digital video recorder may initiate recording of the media content. After initiating recording of the media content, a signal quality metric of the first signal is determined at 306. For example, a signal-to-noise ratio, signal strength, or bit-rate of the first signal may be determined.

Advancing to 308, a determination is made that the signal quality metric of the first signal is below a specified threshold. Proceeding to 310, a determination is made the media content is available via a second signal. For example, a determination may be made that the media content, such as a television show, is being simulcast on a different channel or will be re-transmitted at a subsequent time. In a particular embodiment, an electronic program guide may be queried to determine that the media content is scheduled for re-transmission via a second signal. Moving to 312, recording of the second signal including the media content is scheduled. For example, a set-top box device may request a digital video recorder schedule recording of the second signal. The digital video recorder may be located at a network of the service provider, such as the digital video recorder 150, or at a customer premise, such as digital video recorder 126. The method ends at 314.

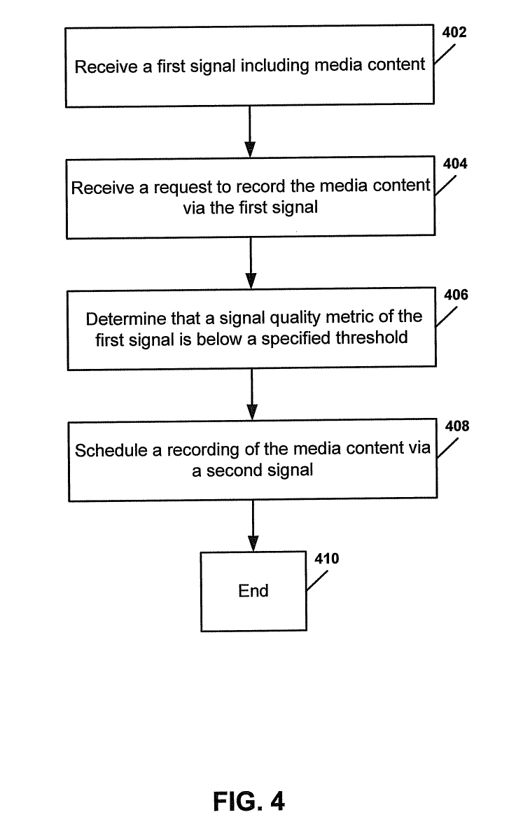

FIG. 4 is a flow diagram of a third particular embodiment of method of scheduling recording of media content. At 402, a first signal including media content is received. For example, the first signal may be received at a digital video recorder, such as the digital recorder 126 or the digital video recorder 150 illustrated in FIG. 1. For example, the media content may include a television show, movie, or video-on-demand program. Moving to 404, a request to initiate recording of the media content via the first signal is received. Continuing to 406, a determination is made that the signal quality metric of the first signal is below a specified threshold. Proceeding to 408, a recording of the media content via a second signal is scheduled. The method ends at 410.

In a particular embodiment, scheduling the recording of the second signal may include the digital video recorder determining that a signal quality metric of the first signal is below a specified threshold, and notifying a set-top box device that the signal quality metric of the first signal is below the specified threshold. The digital video recorder may receive instructions from the set-top box device requesting that the digital video recorder schedule recording of the second signal. The instructions from the set-top box device may include a time, a date, and a channel for recording the second signal. In a particular embodiment, scheduling recording of the second signal may include the digital video recorder or the set-top box device querying an electronic program guide, such as the electronic program guide server 134 of FIG. 1. Scheduling recording of the second signal may also include determining a time and channel that the second signal is being transmitted, and scheduling recording of the second signal based on the time and the channel.

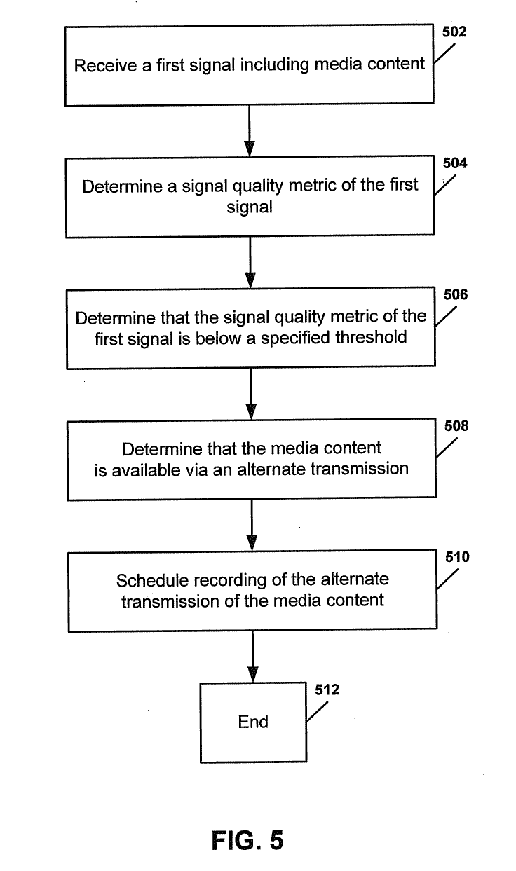

FIG. 5 is a flow diagram of a fourth particular embodiment of a method of scheduling recording of media content. At 502, a first signal including media content is received. For example, the media content may be a television show, movie, or video-on-demand program. Moving to 504, a signal quality metric of the first signal is determined. Continuing to 506, a determination is made that the signal quality metric of the first signal is below a specified threshold. Advancing to 508, a determination is made that the media content is available via an alternate transmission. For example, an electronic program guide may be queried to determine whether the media content is currently simulcast or whether the media content will be re-transmitted at a subsequent time. Proceeding to 510, a recording of the media content via the alternate transmission is scheduled. For example, the recording of the re-transmission of the media content may be scheduled at a digital video recorder, such as the digital video recorder 126 or the digital video recorder 150 in FIG. 1. The method ends at 512.

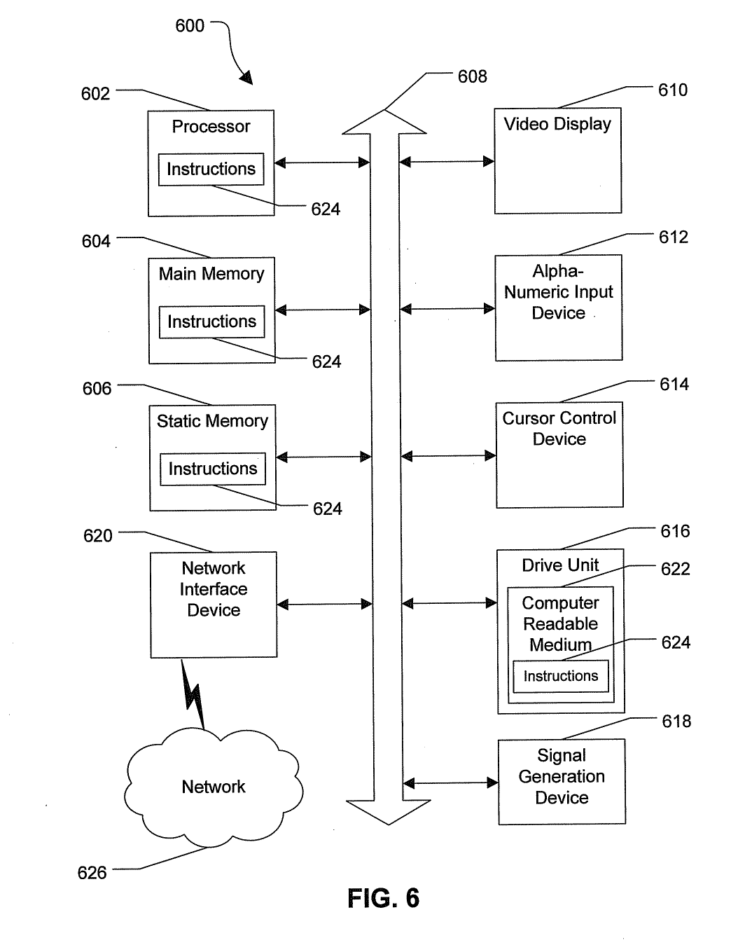

Referring to FIG. 6, an illustrative embodiment of a general computer system is shown and is designated 600. The computer system 600 can include a set of instructions that can be executed to cause the computer system 600 to perform any one or more of the methods or computer based functions disclosed herein. The computer system 600, or any portion thereof, may operate as a standalone device or may be connected, e.g., using a network, to other computer systems or peripheral devices, including a media library server, an electronic program guide (EPG) server, a billing server, a media content server, a digital video recorder, or a set-top box device, as shown in FIG. 1.

In a networked deployment, the computer system may operate in the capacity of a server, such as a video server or application server, or a set-top box device. The computer system 600 can also be implemented as or incorporated into various devices, such as a personal computer (PC), a tablet PC, a set-top box (STB) device, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics-processing unit (GPU), or both. Moreover, the computer system 600 can include a main memory 604 and a static memory 606 that can communicate with each other via a bus 608. As shown, the computer system 600 may further include a video display unit 610, such as a liquid crystal display (LCD), an organic light emitting diode (OLED), a flat panel display, a solid-state display, or a cathode ray tube (CRT). Additionally, the computer system 600 may include an input device 612, such as a keyboard, and a cursor control device 614, such as a mouse. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an email or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal including computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.52(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method at a set-top box, comprising:
receiving a first signal, the first signal including media content;
determining a signal quality metric of the first signal; and
scheduling recording of the media content via a second signal after determining that the signal quality metric of the first signal is below a specified threshold.

2. The method of claim 1, wherein scheduling recording of the media content comprises:
determining whether the media content is available via the second signal after determining that the signal quality metric of the first signal is below the specified threshold; and
scheduling recording of the media content via the second signal after determining that the media content is available via the second signal.

3. The method of claim 2, wherein determining whether the media content is scheduled for transmission comprises querying an electronic program guide.

4. The method of claim 1, wherein the second signal is scheduled for transmission subsequent to the first signal.

5. The method of claim 3, wherein the second signal is scheduled for transmission contemporaneously with the first signal.

6. The method of claim 1, further comprising initiating recording of the media content at a digital video recorder prior to determining the signal quality metric of the first signal.

7. The method of claim 1, wherein determining the signal quality metric of the first signal comprises determining a signal-to-noise ratio of the first signal.

8. The method of claim 1, wherein the first signal is received via a satellite transmission.

9. The method of claim 1, wherein the first signal is received via an Internet Protocol based transmission.

10. The method of claim 1, wherein the first signal is received via a cable network transmission.

11. The method of claim 1, wherein scheduling recording of the media content via the second signal further comprises instructing a digital video recorder to record the second signal.

12. The method of claim 11, wherein the digital video recorder is located at a media content distribution network.

13. A method at a digital video recorder, comprising:
receiving a first signal, the first signal including a media content;
receiving a request to record the media content via the first signal; and
scheduling a recording of the media content via a second signal after determining that a signal quality metric of the first signal is below a specified threshold.

14. The method of claim 13, wherein scheduling the recording of the media content via the second signal comprises:
sending a message to a set-top box device indicating that the signal quality metric of the first signal is below the specified threshold; and
receiving instructions from the set-top box device to schedule the recording of the media content via the second signal.

15. The method of claim 14, wherein the instructions from the set-top box device include a time, a date, and a channel to record the media content via the second signal.

16. The method of claim 13, wherein scheduling the recording of the media content via the second signal comprises:
querying an electronic program guide;
determining a time and a channel of the second signal; and
scheduling the recording of the media content via the second signal based on the time and the channel.

17. The method of claim 16, wherein the electronic program guide is located at a server at a media content distribution network.

18. A computer-readable storage medium, comprising:
operational instructions, that when executed by a processor, cause the processor to receive a first signal, the first signal including media content;
operational instructions, that when executed by the processor, cause the processor to determine a signal quality metric of the first signal; and
operational instructions, that when executed by the processor, cause the processor to determine whether the media content is available via an alternate transmission after determining that the signal quality metric of the first signal is below a specified threshold.

19. The computer-readable storage medium of claim 18, further comprising operational instructions, that when executed by the processor, cause the processor to schedule a recording of the alternate transmission of the media content after determining that the alternate transmission is available.

20. The computer-readable storage medium of claim 18, wherein the recording of the alternate transmission of the media content is scheduled at a network-based digital video recorder.

21. The computer-readable storage medium of claim 18, further comprising operational instructions, that when executed by the processor, cause the processor to access an electronic program guide to determine whether the alternate transmission of the media content is available.

22. A system, comprising:
an interface to receive a first signal including media content; and
a signal quality module to determine a first signal quality metric of the first signal;
a media content control module to determine whether the media content is available via a second signal when the first signal quality metric is below a specified threshold, and to schedule recording of the second signal after determining that the media content is available via a second signal.

23. The system of claim 22, wherein the second signal is a simulcast with the first signal and wherein a second signal quality metric of the second signal is greater than the first signal quality metric.

24. The system of claim 22, wherein the signal quality module is further adapted to determine the first signal quality metric by determining a strength of the first signal.

25. The system of claim 22, wherein the signal quality module is further adapted to determine the first signal quality metric by determining a bit-rate of the first signal.
